(19) United States
(12) Patent Application Publication
(10) Pub. No.: US 2025/0300374 A1
(43) Pub. Date: Sep. 25, 2025

(54) INTEGRATED COMPRESSION LIMITER AND GROUND BLOCK ASSEMBLIES FOR VEHICULAR ELECTRICAL SYSTEMS

(71) Applicant: GM GLOBAL TECHNOLOGY OPERATIONS LLC, Detroit, MI (US)

(72) Inventor: Kevin Updike, Canton, MI (US)

(73) Assignee: GM GLOBAL TECHNOLOGY OPERATIONS LLC, Detroit, MI (US)

(21) Appl. No.: 18/610,695

(22) Filed: Mar. 20, 2024

(51) Int. Cl. H01R 4/64; B60R 16/02; H01R 4/34; H01R 43/26

(52) U.S. Cl. CPC H01R 4/64; B60R 16/0207; H01R 4/34; H01R 43/26

(57) ABSTRACT

Presented are integrated compression limiter and ground block (CLB) assemblies for electrically coupling and physically mounting components to vehicle structures, methods for making/using such CLB assemblies, and vehicles equipped with such CLB assemblies. A CLB assembly includes a substantially rigid and electrically conductive central body, which defines therethrough a compression limiter slot that receives a mounting fastener to thereby physically mount a vehicle component and electrically couple multiple ground wires to the vehicle's load-bearing ground structure. An electrically conductive platform projects from one side of the central body and includes a ground terminal that electrically couples, e.g., via a conductive fastener and terminal connector, with one of the electrical ground wires. Another electrically conductive platform projects from another side of the central body and includes another ground terminal that electrically couples, e.g., via another conductive fastener and terminal connector, with another one of the electrical ground wire.

### INTRODUCTION

The present disclosure relates generally to electrical systems of motor vehicles. More specifically, aspects of this disclosure relate to ground blocks for grounding electrical components and compression limiters for mounting electrical components of automobiles.

Current production motor vehicles, such as the modern-day automobile, are originally equipped with a network of onboard controllers, sensors, communications devices, vehicle accessories, and assorted other electronic components that are distributed across the vehicle body. A resident electrical system governs the transfer of current between each of the vehicle's electronic components and a rechargeable energy storage system (RESS) that supplies the requisite power for operating the vehicle and any of its attendant peripheral loads. To provide a secure and stable path for dissipating excess system charge, the vehicle's electrical system may incorporate multiple grounding points that electrically connect the on-vehicle power sources and electrical devices to a low-resistance charge sink. Since a physical coupling between a moving vehicle and the roadway ground may not be practical, the resident electrical system uses the vehicle's chassis and/or body as a common electrical ground. A grounding terminal block—or “ground block” for brevity—may be employed as an electrical connector for coupling one or more conductive wires of the vehicle's electrical system to the vehicle chassis/body.

### SUMMARY

Presented below are integrated compression limiter and ground block (CLB) assemblies for electrically coupling and physically mounting components to load-bearing grounding structures, methods for making and methods for using such CLB assemblies, and motor vehicles equipped with such CLB assemblies. By way of illustration, unitary CLB assemblies are disclosed that combine the functionality of a compression limiter, e.g., for mounting a wiring channel to a vehicle chassis/body, with the functionality of a ground block, e.g., for grounding wiring harness wires in the wiring channel to the vehicle chassis/body. The CLB assembly may include a single-piece connector body that is stamped or cast from an electrically conductive and rigid metallic material, such as copper or aluminum. A central “compression” region of the connector body incorporates geometry (e.g., an elongated non-threaded fastener slot) that functions as a compression limiter. A pair of transverse “grounding” platforms project from opposing sides of the connector body's compression region and each incorporates geometry (e.g., arcuate wings or raised posts) that functions as a grounding terminal.

An electrical wire of the wiring harness in the wiring channel is electrically coupled to each grounding platform using, for example, a crimp-type wire terminal and a conductive threaded fastener. The ground conductivity of the wire is transferred from the grounding platform, through the compression region, and to the vehicle chassis/body using a conductive threaded fastener. The CLB assembly may be mounted onto a channel leg of the wiring channel or a module bracket in the immediate vicinity of the bundle routing. Mounting of the CLB assembly may be achieved via compression fit, snap fit, rivet, overmolding, etc., of the connector body onto a ground block platform of the channel leg. Attendant benefits for at least some of the disclosed CLB assemblies may include a reduction in a total number of grounding locations along with simplified installation of each CLB assembly to its respective grounding location. Additional benefits may include an optimized assembly design with a corresponding reduction in part count, assembly time, and gross vehicle weight (GVW).

Aspects of this disclosure are directed to integrated compression limiter and ground block assemblies for electrically coupling and physically mounting vehicle components to load-bearing vehicle grounding structures. In an example, a CLB assembly includes a substantially rigid and electrically conductive central body, which defines therethrough a compression limiter slot that physically mounts a vehicle component, such as a wire channel leg, to a select vehicle ground structure, such as a chassis rocker rail or bulkhead panel, and concomitantly electrically couples multiple electrical wires, such as a pair of wiring harness grounding wires, to the vehicle ground structure. A left (first) electrically conductive platform, which projects from a left (first) side of the central body, includes a left (first) ground terminal that electrically couples with one of the electrical ground wires. Likewise, an electrically conductive right (second) platform, which projects from a right (second) side of the central body, includes a right (second) ground terminal that electrically couples with another one of the electrical ground wires.

Additional aspects of this disclosure are directed to motor vehicles equipped with CLB assemblies for electrically coupling and physically mounting vehicle components to load-bearing vehicle grounding structures. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, aircraft, watercraft, spacecraft, e-bikes, etc. In an example, a motor vehicle includes a vehicle body with an internal vehicle chassis, a passenger compartment, multiple road wheels mounted to the vehicle body (e.g., via corner modules coupled to the unibody or body-on-frame chassis), and other standard original equipment. A prime mover, which may be in the nature of an internal combustion engine (ICE) assembly and/or an electric traction motor, is attached to the vehicle body and selectively drives one or more of the road wheels to thereby propel the motor vehicle.

Continuing with the discussion of the foregoing example, the motor vehicle is also equipped with a resident electrical system that includes one or more wiring channels, each of which has multiple electrical wires routed through a wire channel, and at least one channel leg with a mounting platform that both project from the wire channel. The vehicle employs one or more CLB assemblies to securely mount the wire channel(s) to the vehicle body/chassis. Each CLB assembly includes three electrically conductive fasteners, such as threaded hex-head bolts with mating nuts, and a CLB connector unit with a central body and a pair of platforms that are integrally formed as a single-piece structure from a substantially rigid, electrically conductive metallic material. The central body segment of the single-piece CLB connector unit is mounted onto the channel leg's mounting platform, e.g., via compression-fit, snap-fit, overmolding, fastener, etc. The central body includes a compression limiter slot that receives therethrough a first fastener and thereby physically mounts the channel leg to the vehicle body/chassis ground structure and also electrically couples first and second ground wires to the ground structure. Each platform segment of the single-piece CLB connector unit projects from a respective side of the central body, and includes a respective ground terminal with a respective fastener hole that receives a respective fastener and thereby electrically couples with the respective ground wire.

Further aspects of this disclosure are directed to manufacturing systems, workflow processes, and control logic for making or for using any of the herein described CLB assemblies, vehicle electrical systems, and motor vehicles. In an example, a method is presented for manufacturing a compression limiter and ground block assembly for a vehicle. The vehicle includes a vehicle component, a ground structure, and multiple electrical wires. This representative method includes, in any order and in any combination with any of the above and below disclosed options and features: forming a central body with a substantially rigid and electrically conductive body material such that the central body includes a compression limiter slot configured to physically mount the vehicle component and electrically couple the electrical wires to the ground structure; forming a first platform with an electrically conductive first material such that the first platform projects from a first side of the central body and includes a first ground terminal configured to electrically couple with a first ground wire of the electrical wires; and forming a second platform with an electrically conductive second material such that second first platform projects from a second side of the central body and includes a second ground terminal configured to electrically couple with a second ground wire of the electrical wires.

For any of the disclosed CLB assemblies, vehicles, and methods, the central body and the two outwardly projecting platforms may be fabricated as a bipartite or tripartite assembly or, for at least some desired applications, may be integrally formed as a single-piece unit. As a further option, the central body may include an oblong ring that defines therethrough an unthreaded compression limiter slot. In this instance, an electrically conductive fastener may be passed through, without threadably mating with, the compression limiter slot. This fastener then passes through a mounting structure of the vehicle component (e.g., the mounting platform of the channel leg) and mates with a complementary slot in the load-bearing ground structure to thereby mount the vehicle component and electrically couple the electrical wires to the vehicle ground structure. As another option, each CLB assembly platform includes a respective arcuate wing that projects transversely from the respective side of the central body. These platforms may project from opposite sides of the central body in opposite directions from each other. In this instance, the CLB connector unit may be a stamped metal plate such that the central body and the two platforms are all formed from the same metallic material.

For any of the disclosed CLB assemblies, vehicles, and methods, the CLB assembly may include multiple electrically conductive threaded fasteners, each of which mates with a respective fastener hole in a respective one of the ground terminals to thereby electrically couple a respective ground wire to the single-piece CLB connector unit. As another option, the CLB assembly may include multiple electrically conductive crimp-type terminal connectors, each of which is connected via a respective threaded fastener to a respective CLB assembly platform ground terminal and crimps thereto a respective ground wire. It is envisioned that the ground wires may electrically couple to the CLB assembly platforms using alternative connector devices (e.g., binding posts, terminal rings, terminal spades, spring-biased quick connectors, etc.) or may directly connect to the CLB assembly platforms (e.g., via soldering, welding, etc.).

For any of the disclosed CLB assemblies, vehicles, and methods, the CLB assembly's central body may be a substantially flat, square-shaped mounting base that defines therethrough the compression limiter slot. As a further option, each CLB assembly platform may include a respective raised post that projects substantially orthogonally from a respective side of the central body. In this instance, the CLB assembly may include three electrically conductive fasteners: a first threaded fastener that passes through, without threadably mating with, the compression limiter slot; a second threaded fastener that threadably mates with a threaded fastener hole of a respective ground terminal of one of the raised posts; and a third threaded fastener that threadably mates with a threaded fastener hole of the ground terminal of the other raised post. Optionally, the single-piece CLB connector unit may be a cast metal structure such that the central body and the two outwardly projecting platforms are all formed from the same metallic material.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with a high-voltage (HV) electrical system that employs integrated compression limiter and ground block (CLB) assemblies for mounting components and grounding power cables to the vehicle chassis in accordance with aspects of the present disclosure.

FIG. 2 is a perspective-view illustration of a section of a representative wiring channel with a mounting platform of a channel leg bearing an integrated compression limiter and ground block assembly in accordance with aspects of the present disclosure.

FIG. 3 is a perspective-view illustration of a representative stamped-metal CLB connector unit for an integrated CLB assembly in accordance with aspects of the present disclosure.

FIG. 4 is a perspective-view illustration of a representative cast-metal CLB connector unit for an integrated CLB assembly in accordance with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless explicitly disclaimed: the singular includes the plural and vice versa (e.g., indefinite articles “a” and “an” are to be construed as meaning “one or more” unless expressly disclaimed); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

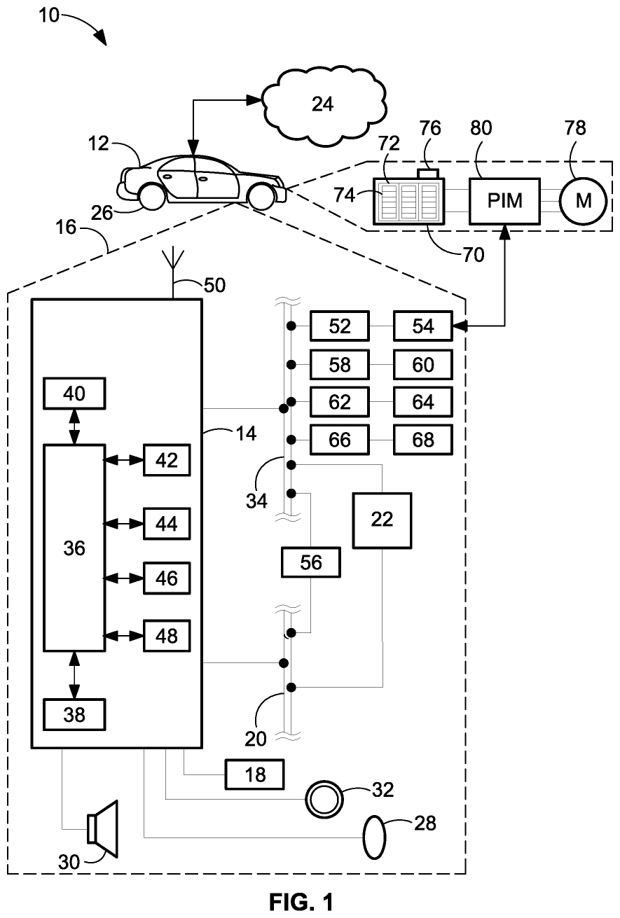

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into an HV electrical system of an electric-drive vehicle should be appreciated as a non-limiting implementation of disclosed features. As such, it will be understood that aspects and features of this disclosure may be applied to other electrical systems, incorporated into any logically relevant type of motor vehicle, and utilized for both automotive and non-automotive applications alike. Moreover, only select components of the motor vehicles and electrical systems are shown and described in detail herein. Nevertheless, the vehicles and systems discussed below may include numerous additional and alternative features, and other available peripheral hardware, for carrying out the various methods and functions of this disclosure.

The representative vehicle 10 of FIG. 1 is originally equipped with a centerstack telecommunications and information (“telematics”) unit 14 that wirelessly communicates, e.g., via cell towers, satellite service, etc., with a remotely located cloud computing host service 24 (e.g., ONSTAR®). Other in-vehicle hardware components 16 shown in FIG. 1 include, as non-limiting examples, an electronic video display device 18, a microphone 28, audio speakers 30, and assorted user input controls 32 (e.g., buttons, knobs, switches, touchscreens, etc.). These hardware components 16 function as a human/machine interface (HMI) that enables a user to communicate with the telematics unit 14 and other components both resident to and remote from the vehicle 10. Microphone 28, for instance, provides occupants with means to input verbal commands. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is the network connection interface 34, suitable examples of which include twisted pair/fiber optic Ethernet switches, parallel/serial communications buses, local area network (LAN) interfaces, controller area network (CAN) interfaces, and the like. Network connection interface 34 enables the vehicle hardware 16 components to send and receive signals with one another and with systems and subsystems both onboard and off-board the vehicle body/chassis 12. This allows the vehicle 10 to perform assorted vehicle functions, such as modulating powertrain output, activating a vehicle brake system, controlling vehicle steering, regulating charge and discharge of vehicle batteries, and other automated functions. For instance, the in-vehicle telematics unit 14 of FIG. 1 may receive and transmit signals to/from a Powertrain Control Module (PCM) 52, an Onboard Charging Module (OBCM) 54, an Electronic Battery Control Module (EBCM) 56, a Steering Control Module (SCM) 58, a Brake System Control Module (BSCM) 60, and assorted other vehicle ECUs.

With continuing reference to FIG. 1, telematics unit 14 is an onboard computing device that provides a mixture of services, both individually and through its communication with other networked devices. The telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to an integrated circuit (IC) real-time clock (RTC) 42 and one or more electronic memory devices 38, each of which may take on the form of a CD-ROM, solid-state drive (SSD) memory, hard-disk drive (HDD) memory, semiconductor memory, etc.

Long-range communication (LRC) capabilities with off-board devices may be provided via a cellular communication chipset, a navigation and location component (e.g., global positioning system (GPS) transceiver), and/or a wireless modem, all of which are collectively represented at 44. Short-range communication (SRC) may be provided via a close-range wireless communication device 46 (e.g., a BLUETOOTH® unit), a dedicated short-range communications (DSRC) component 48, and/or a dual antenna 50. The above-described communications devices may provision data exchanges as part of a periodic broadcast in a vehicle-to-vehicle (V2V) communications system or a vehicle-to-everything (V2X) communications system. It should be understood that the vehicle 10 may be implemented without one or more of the above-listed components or, optionally, may include additional components and functionality as desired for a particular end use.

CPU 36 receives sensor data from one or more sensing devices that use, for example, photo detection, radar, laser, ultrasonic, optical, infrared, or other apposite technology, including short range communications technologies (e.g., DSRC) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of on-vehicle sensors may be adapted, singly or collectively, to a given vehicle platform for achieving a desired level of autonomous vehicle operation.

To propel the motor vehicle 10, an electrified powertrain is operable to generate and deliver tractive torque to one or more of the vehicle's drive wheels 26. The powertrain is represented in FIG. 1 by an electric traction motor 78 that is connected to a rechargeable energy storage system (RESS), which may be in the nature of a chassis-mounted traction battery pack 70. The battery pack 70 may contain one or more battery modules 72 each housing a group of electrochemical battery cells 74, such as lithium-ion or lithium-polymer battery cells of the pouch, can, or prismatic type. One or more electric machines, such as a variable-speed, multiphase motor/generator (M) unit 78, draw electrical power from and, optionally, deliver electrical power to one or more rechargeable battery units, such as traction battery pack 70. A high-voltage (HV) electrical system with a power inverter module (PIM) 80 electrically connects the battery pack 70 to the motor/generator unit(s) 78 and modulates the transfer of electrical current therebetween. The battery pack 70 may be configured such that module management, cell sensing, and module-to-host communications functionality is integrated directly into each module 72 and performed wirelessly via a wireless-enabled cell monitoring unit (CMU) 76.

During operation of the automobile 10, it is oftentimes necessary to electrically connect select segments of the vehicle's high-voltage (HV) electrical system to the vehicle's internal chassis and/or body 12 to provide a secure and stable grounding path for expelling excess charge from the system. Traditional grounding terminal blocks function solely as an electrical connector for electrically coupling system wires to the vehicle chassis/body. Presented below, in contrast, are integrated compression limiter and ground block (CLB) assemblies that both physically mount vehicle components to load-bearing vehicle structures and electrically couple vehicle components to vehicle grounding structures. These CLB assemblies integrate the functionality of a ground block with the functionality of a compression limiter into a single compact and light-weight unit. It may be desirable that the ground block and compression limiter features be fabricated as a one-piece “connector unit” structure, e.g., via metal forming, casting, 3D printing, precision machining, laser cutting, etc.

For automotive applications, a CLB assembly may be secured to a plastic mounting platform of a wiring channel leg using, for example, a compression fit, snap fit, rivet, overmolding, or other similarly suitable attachment process. To this end, the mounting platform may be formed with a recessed cavity that is shaped and sized to coincide with the outer periphery of the CLB connector unit in order to facilitate proper alignment and attachment of the connector unit with the mounting platform and, thus, with the wiring channel leg. Fabrication of the metal CLB connector unit may include the installation of a surface-mount nut for each CLB ground terminal connection point. Alternatively, fabrication of the metal CLB connector unit may include tapping a thread-cut hole for each CLB ground terminal connection point. For at least some designs, an electrical terminal connector may be secured, e.g., via crimp, clamp, weld, etc., at one end thereof to a ground wire and hard fastened, e.g., via a threaded bolt and mating nut, at the opposite end thereof for grounding conductivity to the CLB connector unit. The CLB assembly may then be hard fastened to the vehicle chassis/body, e.g., via a threaded bolt and body-mounted nut or via a threaded nut and a body-mounted stud.

While described as mounting a single component to a load-bearing vehicle structure, disclosed CLB assemblies may be scaled to attach multiple components to a load-bearing vehicle structure. It is also envisioned that disclosed CLB assemblies may electrically couple with a single wire or, if desired, two or more wires within the intended scope of this disclosure. As another option, disclosed CLB assemblies are modifiable to incorporate alternate grounding fastener types, locations, and patterns. Disclosed concepts are not limited to mounting a plastic wire channel to a chassis rocker rail, bulkhead panel, or dash panel, but may be applied to mounting assorted other components (e.g., battery packs, power inverters, electronics packages, etc.) to a myriad of load-bearing, electrically conductive vehicle structures (e.g., deck lids, door beams, frame rails, etc.). Attendant benefits for at least some disclosed concepts may include a significant reduction in the total number of uniquely defined grounding locations. Reductions in total number of ground attachments, Base Engineered Content (BEC) time, casting boss formations, and complex body formations accommodating the attachments may also be realized. Other attendant benefits may include reduced wire lengths required to align with provided grounding locations, and simplification of the BEC assembly as the compression limiter and ground block assembly may be packaged near the wire bundle routing.

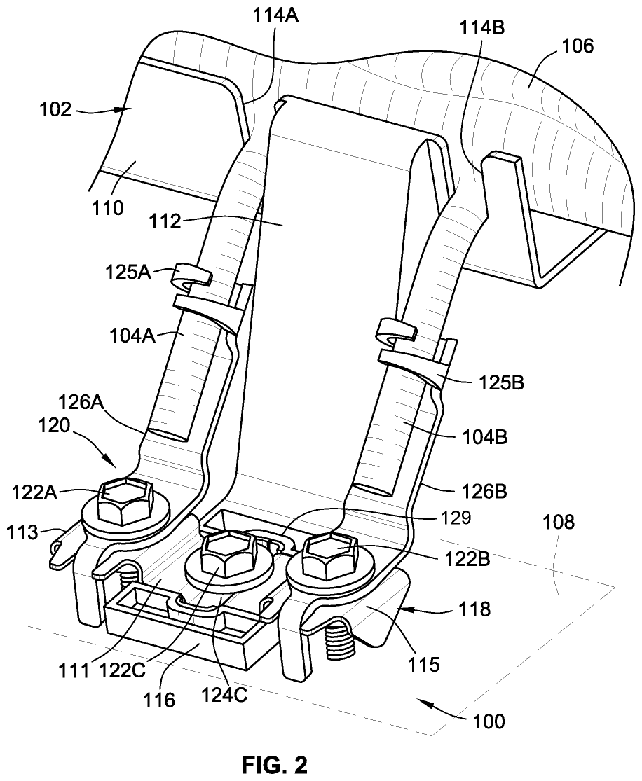

Turning next to FIG. 2, there is shown a non-limiting example of an integrated compression limiter and ground block assembly 100 that rigidly mounts a plastic vehicle component, such as internal wiring channel 102, and electrically couples an electric vehicle component, such as ground wires 104A and 104B of wiring harness 106, to a load-bearing, electrically conductive vehicle structure, such as chassis rail 108. The segments of the wiring channel 102 visible in FIG. 2 are generally limited to a U-shaped wiring channel 110 and an L-shaped channel leg 112 that is integral with and projects at an oblique angle from the wiring channel 110. A pair of wire cutouts 114A and 114B extends through a sidewall of the wiring channel 110, with each cutout 114A, 114B located on a respective side of the channel leg 112 and receiving therethrough a respective one of the ground wires 104A, 104B. Projecting transversely outward from a distal end of the channel leg 112 is a polyhedral CLB mounting platform 116, which securely mounts thereon the integrated CLB assembly 100.

For simplicity of design and ease of manufacture, the CLB assembly 100 of FIG. 2 may be a quadripartite device that is generally composed of a CLB connector unit 118 and three electrically conductive fasteners 120. While an assortment of available fastener options may be employed, including rivets, grommets, screws, etc., each of the fasteners 120 is shown as a threaded hex-head bolt 122A, 122B and 122C that threadably mates with a surface-mount nut 124A, 124B and 124C. The lefthand and righthand surface-mount nuts 124A, 124B may be aligned with complementary through-holes in the CLB connector unit 118 and welded to an underside surface of the connector unit 118. Alternatively, the surface-mount nuts 124A, 124B, 124C may be replaced by snap-in or surface-mount studs that threadably mate with torque-on hexagonal nuts. As another option, the surface-mount nuts 124A, 124B and 124C may be altogether omitted from the system configuration of FIG. 2 and replaced with internally threaded fastener holes in the connector unit 118 and chassis rail 108.

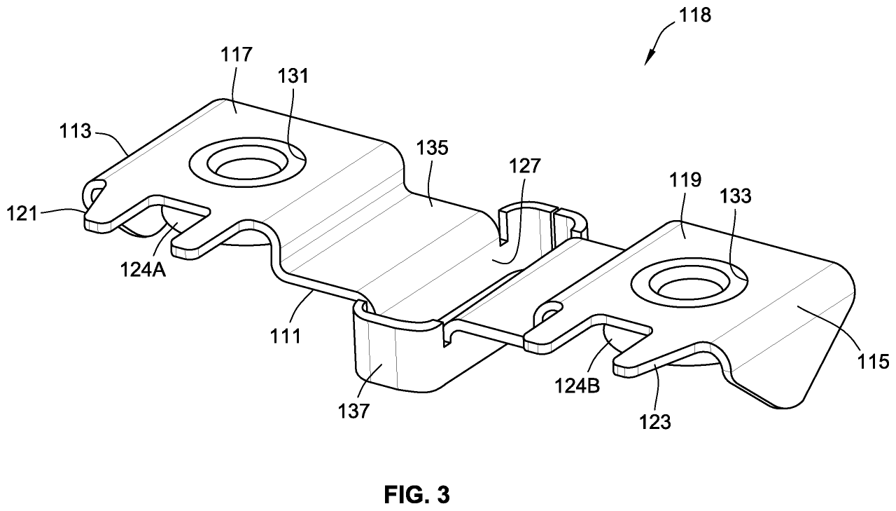

The CLB connector unit 118 of FIGS. 2 and 3 may be divided into three interconnected and electrically conductive segments: (1) a central body 111 segment, (2) a left-side (first) elevated platform 113 segment, and (3) a right-side (second) elevated platform 115 segment. Each platform 113, 115 segment includes a substantially flat ground terminal 117 and 119 (FIG. 3) that receives thereon and electrically couples with one of the ground wires 104A, 104B. As shown, the two ground terminal 117, 119 portions of the elevated platforms 113, 115 are substantially coplanar with each other and substantially parallel to, yet vertically offset from, the central body 111. A two-pronged connector port 121 and 123 (FIG. 3) projects from a lateral edge of each ground terminal 117, 119 for receiving an alignment tab of a respective terminal connector 126A and 126B. It is envisioned that the central body 111 and the two outwardly projecting platforms 113, 115 may be fabricated as a bipartite or tripartite assembly or, as shown, may be integrally formed as a single-piece, unitary structure from a substantially rigid and electrically conductive metallic material, such as copper or aluminum.

With continuing reference to FIG. 2, an optional pair of electrically conductive terminal connectors 126A and 126B may be interposed between and electrically connect the wiring harness 106 and the CLB assembly 100. In particular, a distal end of a lefthand (first) crimp-type terminal connector 126A is removably coupled via the left-side (first) threaded fastener 122A to the ground terminal 117 portion of the left-side platform 113. A proximal end of the lefthand terminal connector 126A includes a pair of wire and shielding crimps 125A that collectively crimp thereto the left-side ground wire 104A. In the same vein, a distal end of a righthand (second) crimp-type terminal connector 126B is removably coupled via the right-side (second) threaded fastener 122B to the ground terminal 119 portion of the right-side platform 115. A proximal end of the righthand terminal connector 126B includes a pair of wire and shielding crimps 125B that collectively crimp thereto the right-side ground wire 104B. It is envisioned that the ground wires 104A, 104B may electrically couple to the CLB assembly 100 using different connector designs (e.g., binding posts, terminal rings, terminal spades, spring-biased quick connectors, etc.) or may directly connect to the assembly platforms 113, 115 (e.g., via soldering, welding, etc.).

Turning to FIG. 3, the substantially rigid and electrically conductive central body 111 portion of the connector unit 118 includes a compression limiter slot 127 that is designed to both physically mount a polymeric vehicle component to a load-bearing vehicle structure and concomitantly electrically couple an electric vehicle component to a vehicle ground structure. While a myriad of shapes and sizes may be used, the compression limiter slot 127 is an oblong discorectangular (pill) shaped through-hole sans internal threads. The compression limiter slot 127 axially aligns with a complementary fastener slot (not visible) extending through the plastic channel leg's integral mounting platform 116. To facilitate proper alignment and attachment of the CLB assembly 100 with the wiring channel 102, the mounting platform 116 is formed with a recessed inlay cavity 129 that is shaped and sized to coincide with the outer periphery of the CLB connector unit 118. When properly secured within this inlay cavity 129, the CLB connector unit 118 structurally reinforces the mounting platform 116 during mounting of the wiring channel 102 to the chassis rail 108. To securely mount the wiring channel 102 to the chassis rail 108, the central (third) threaded fastener 122C is first passed through the compression limiter slot 127, then passed through the fastener slot in the mounting platform 116, and thereafter torqued down into the complementary surface-mount nut 124C on the chassis rail 108. Since the compression limiter slot 127 lacks internal threads, the fastener 122C does not threadably mate with the slot 127.

In addition to securing the wiring channel 102 to the chassis rail 108, the CLB assembly 100 also electrically grounds the wiring harness ground wires 104A and 104B to the chassis rail 108. By way of example, and not limitation, each of the grounding platforms 113, 115 is electrically connected to and projects transversely outward from a respective side of the CLB assembly's central body 111. While not per se required, it may be desirable that these platforms 113, 115 project from opposite lefthand and righthand sides of the central body 111 in opposite directions from each other. To electrically connect the wiring harness 106 to the CLB assembly 100, the left-side threaded fastener 122A is first passed through a complementary hole (not visible) in the distal end of the lefthand terminal connector 126A, then passed through a lefthand (first) fastener hole 131 of the lefthand (first) ground terminal 117, and finally torqued down into the surface-mount nut 124A. Along the same lines, the right-side threaded fastener 122B is first passed through a complementary hole (not visible) in the distal end of the righthand terminal connector 126B, then passed through a righthand (second) fastener hole 133 of the righthand (second) ground terminal 119 and threadably mated with the surface-mount nut 124B.

FIG. 3 illustrates a representative example of a stamped-metal CLB connector unit for an integrated CLB assembly. For instance, the CLB connector unit 118 is depicted as a one-piece metal plate stamping in which the central body 111 and elevated platforms 113, 115 are integrally formed from the same metallic material. In the illustrated example, the central body 111 is formed as an elongated and planar mounting base 135 that is integral with an oblong discorectangular-shaped ring 137. This oblong ring 137, which is centrally located in and projects downward from the mounting base 135, defines therethrough the compression limiter slot 127. Each of the elevated platforms 113, 115 of FIG. 3 is shaped as an arcuate wing that projects transversely outward from a respective side of the central body's mounting base 135.

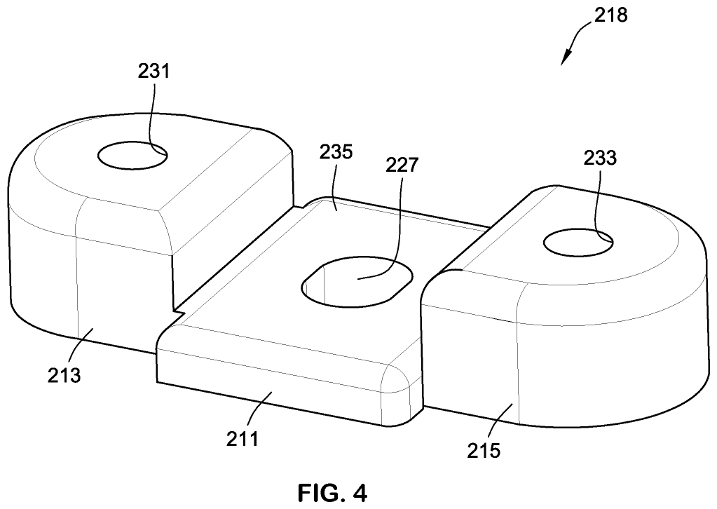

FIG. 4 illustrates a representative example of a cast-metal CLB connector unit for an integrated CLB assembly. As an example, the CLB connector unit 218 is portrayed as a one-piece metal casting in which a central body 211 and a pair of elevated platforms 213 and 215 are integrally formed with one another from the same metallic material. Although differing in appearance, it is envisioned that the CLB connector unit 218 of FIG. 4 may include any of the features and options described above with respect to the integrated CLB assembly 100 of FIG. 2 or the CLB connector unit 118 of FIG. 3, and vice versa. In this illustrated example, the central body 211 is formed as a substantially flat, square-shaped mounting base 235 that defines therethrough a compression limiter slot 227. Each of the elevated platforms 213, 215 is cast as a plinth-like raised post that projects substantially orthogonally from a respective side of the central body 211. Similar to the connector unit 118 of FIG. 3, the central threaded fastener 122C is passed through, without threadably mating with, the compression limiter slot 227. At the same time, the left-side threaded fastener 122A threadably mates with a threaded fastener hole 231 in the lefthand raised post 213, and the right-side threaded fastener 122B threadably mates with a threaded fastener hole 233 in the righthand raised post 215.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A compression limiter and ground block (CLB) assembly for a vehicle having a vehicle component, a ground structure, and multiple electrical wires, the CLB assembly comprising:
a central body formed with a substantially rigid and electrically conductive body material, the central body including a compression limiter slot configured to physically mount the vehicle component and electrically couple the electrical wires to the ground structure;
a first platform projecting from a first side of the central body and formed with an electrically conductive first material, the first platform including a first ground terminal configured to electrically couple with a first ground wire of the electrical wires; and
a second platform projecting from a second side of the central body and formed with an electrically conductive second material, the second platform including a second ground terminal configured to electrically couple with a second ground wire of the electrical wires.

2. The CLB assembly of claim 1, wherein the central body, the first platform, and the second platform are integrally formed as a single-piece CLB connector unit.

3. The CLB assembly of claim 2, wherein the central body includes an oblong ring defining therethrough the compression limiter slot.

4. The CLB assembly of claim 3, further comprising an electrically conductive fastener passing through without threadably mating with the compression limiter slot, wherein the fastener is configured to pass through a mounting structure of the vehicle component and mate with a complementary slot in the ground structure to thereby mount the vehicle component and electrically couple the electrical wires to the ground structure.

5. The CLB assembly of claim 3, wherein the first platform includes a first arcuate wing projecting transversely from the first side of the central body, and the second platform includes a second arcuate wing projecting transversely from the second side of the central body, and wherein the first side is opposite the second side.

6. The CLB assembly of claim 5, wherein the single-piece CLB connector unit is a stamped metal plate, and wherein the body material of the central body, the first material of the first platform, and the second material of the second platform are a same metallic material.

7. The CLB assembly of claim 5, further comprising:
a first threaded fastener mating with a first fastener hole of the first ground terminal to thereby electrically couple the first ground wire to the single-piece CLB connector unit; and
a second threaded fastener mating with a second fastener hole of the second ground terminal to thereby electrically couple the second ground wire to the single-piece CLB connector unit.

8. The CLB assembly of claim 7, further comprising:
a first crimp-type terminal connector connected via the first threaded fastener to the first ground terminal and configured to crimp thereto the first ground wire; and
a second crimp-type terminal connector connected via the second threaded fastener to the second ground terminal and configured to crimp thereto the second ground wire.

9. The CLB assembly of claim 2, wherein the central body includes a planar mounting base defining therethrough the compression limiter slot.

10. The CLB assembly of claim 9, wherein the first platform includes a first raised post projecting substantially orthogonally from the first side of the central body, and the second platform includes a second raised post projecting substantially orthogonally from the second side of the central body, and wherein the first side is opposite the second side.

11. The CLB assembly of claim 10, further comprising:
an electrically conductive first threaded fastener passing through without threadably mating with the compression limiter slot;
an electrically conductive second threaded fastener threadably mating with a first fastener hole of the first ground terminal of the first raised post; and
an electrically conductive third threaded fastener threadably mating with a second fastener hole of the second ground terminal of the second raised post.

12. The CLB assembly of claim 11, wherein the single-piece CLB connector unit is a cast metal structure, and wherein the body material of the central body, the first material of the first platform, and the second material of the second platform are a same metallic material.

13. A motor vehicle, comprising:
a vehicle body with an internal vehicle chassis, the vehicle body and/or the internal vehicle chassis defining a ground structure;
a plurality of road wheels attached to the vehicle body;
a prime mover attached to the vehicle body and configured to drive one or more of the road wheels to thereby propel the motor vehicle;
a vehicle electrical system including a wire channel, a channel leg with a mounting platform projecting from the wire channel, and multiple electrical wires with first and second ground wires routed through the wire channel; and
a compression limiter and ground block (CLB) assembly, including:
a plurality of electrically conductive fasteners including first, second and third fasteners;
a central body mounted onto the mounting platform of the channel leg, the central body including a compression limiter slot receiving therethrough the first fastener and thereby physically mounting the channel leg to the ground structure and electrically coupling the first and second ground wires to the ground structure;
a first platform projecting from a first side of the central body and including a first ground terminal with a first fastener hole receiving the second fastener and thereby electrically coupling with the first ground wire; and
a second platform projecting from a second side of the central body and including a second ground terminal with a second fastener hole receiving the third fastener and thereby electrically coupling with the second ground wire,
wherein the central body, the first platform, and the second platform are integrally formed as a single-piece CLB connector unit from a substantially rigid and electrically conductive metallic material.

14. A method of manufacturing a compression limiter and ground block (CLB) assembly for a vehicle, the vehicle having a vehicle component, a ground structure, and multiple electrical wires, the method comprising:
forming a central body with a substantially rigid and electrically conductive body material such that the central body includes a compression limiter slot configured to physically mount the vehicle component and electrically couple the electrical wires to the ground structure;
forming a first platform with an electrically conductive first material such that the first platform projects from a first side of the central body and includes a first ground terminal configured to electrically couple with a first ground wire of the electrical wires; and
forming a second platform with an electrically conductive second material such that second first platform projects from a second side of the central body and includes a second ground terminal configured to electrically couple with a second ground wire of the electrical wires.

15. The method of claim 14, wherein forming the central body, forming the first platform, and forming the second platform includes integrally forming the central body, the first platform, and the second platform as a single-piece CLB connector unit.

16. The method of claim 15, wherein the central body includes an oblong ring defining therethrough the compression limiter slot.

17. The method of claim 16, wherein the first platform includes a first arcuate wing projecting transversely from the first side of the central body, and the second platform includes a second arcuate wing projecting transversely from the second side of the central body, and wherein the first side is opposite the second side.

18. The method of claim 17, further comprising:
mating a first threaded fastener with a first fastener hole of the first ground terminal to thereby electrically couple the first ground wire to the single-piece CLB connector unit; and
mating a second threaded fastener with a second fastener hole of the second ground terminal to thereby electrically couple the second ground wire to the single-piece CLB connector unit.

19. The method of claim 18, further comprising:
passing an electrically conductive threaded fastener through the compression limiter slot;
passing the electrically conductive threaded fastener through a mounting structure of the vehicle component; and
threadably mating the electrically conductive threaded fastener with a threaded slot in the ground structure to thereby mount the vehicle component and electrically couple the electrical wires to the ground structure.

20. The method of claim 18, further comprising:
crimping a first crimp-type terminal connector to the first ground wire;
connecting the first crimp-type terminal connector to the first ground terminal via the first threaded fastener;
crimping a second crimp-type terminal connector to the second ground wire; and
connecting the second crimp-type terminal connector to the second ground terminal via the second threaded fastener.
